(19) United States
(12) Patent Application Publication
(10) Pub. No.: US 2024/0042391 A1
(43) Pub. Date: Feb. 8, 2024

(54) A SEPARATION DEVICE AND COMPOSITE MEMBRANE

(71) Applicant: NATIONAL UNIVERSITY OF SINGAPORE, Singapore (SG)

(72) Inventors: Juan Alfredo GUEVARA CARRIO, Singapore (SG); Antonio Helio CASTRO NETO, Singapore (SG); Sergio GRANIERO ECHEVERRIGARAY, Singpore (SG)

(73) Assignee: NATIONAL UNIVERSITY OF SINGAPORE, Singapore (SG)

(21) Appl. No.: 18/257,903

(22) PCT Filed: Dec. 16, 2021
(86) PCT No.: PCT/SG2021/050793

§ 371 Date: Jun. 16, 2023

(30) Foreign Application Priority Data
Dec. 16, 2020 (SG) 10202012652S

(51) Int. Cl. B01D 61/36; B01D 69/02; B01D 69/14; B01D 69/12; B01D 71/02; B01D 63/08

(52) U.S. Cl. CPC B01D 61/366; B01D 69/02; B01D 69/14111; B01D 69/1411; B01D 69/1213; B01D 71/0211; B01D 61/3621; B01D 63/087; B01D 2325/36; B01D 2325/04; B01D 2325/02834; B01D 2325/0283; B01D 2313/201

(57) ABSTRACT

The present invention relates to a composite membrane comprising at least one 2D material and an inorganic porous material. The composite membrane described herein may be housed within a separation device which may be used for selective permeation of one or more gaseous compounds.

### CROSS-REFERENCE TO RELATED APPLICATIONS

This application claims the benefit of priority of Singapore patent application No. 10202012652S, filed on 16 Dec. 2020, its contents being hereby incorporated by reference in its entirety.

### TECHNICAL FIELD

The present invention relates to a separation device and a composite membrane housed within the device for separating gas-liquid mixtures.

### BACKGROUND ART

Gas-liquid separation typically involves the extraction of components in vapor form from a liquid or a liquid/vapor mixture based on the differences in physical and chemical properties of components, such as boiling point, molecular size, absorption, etc. Gas-liquid separation is essential in a variety of industrial processes. For instance, in the beverage/alcohol industry, liquids, gas-liquid separation may be used to collect the vapors generated from fermentation or distillation processes. The extraction of components in vapor form from the reaction mixtures during chemical reactions may also be useful to drive a reaction and promote reaction efficiency.

Conventionally, the separation of a gas from a liquid mixture may involve distillation, e.g., applying a high temperature (e.g., above the boiling point of the desired components) to the liquid to allow the phase transition of one or more desired components to vapors, which may thereafter be discharged and collected, e.g. via side draws in a distillation column. However, conventional separation processes are typically energy-intensive and require a high operation cost. Moreover, the high temperatures necessary for the separation may negatively affect substances that may be deactivated or decomposed, especially for active ingredients in the pharmaceutical and food industries.

Membrane-based separations have been considered as alternatives to high-temperature gas-liquid separation. In such separations, the gas separation membranes work as a barrier that allows the selective permeation of specific species in gas/gas or gas/liquid mixtures. Polymer-based membranes such as polyacrylontrile and poly(vinyl alcohol) membranes are commonly used as separation membranes due to their flexibility and their ease of modification. However, polymeric membranes tend to swell at high temperatures (e.g., >120° C.) when vapor molecules permeate into the molecular chains. Therefore, such polymer membranes may be unsuitable for prolonged use under harsh conditions in industrial-scale operations.

Membranes based on two-dimensional materials have also been considered in the field of gas/liquid separation. However, to date, efforts to develop membranes using two-dimensional materials have been limited to laboratory-scale research as the stiffness of 2D materials often makes it prohibitive for such membranes to be employed in large-scale industrial operations.

Therefore, there is a need to provide a novel membrane for a separation device that overcomes or at least ameliorates one or more of the drawbacks described above.

### SUMMARY OF INVENTION

in one aspect, there is provided a composite membrane comprising at least one two-dimensional material and an inorganic porous material. Advantageously, the composite membrane described herein demonstrates selectivity for specific gaseous components in a gas/gas, gas/liquid, or liquid/liquid mixture. The selectivity of the composite membrane may be attributed to the intrinsic physicochemical properties of the two-dimensional material, which is dispersed into and/or laminated onto the inorganic porous material, which allows preferential passage of gaseous components having properties that are compatible with the composite membrane.

Further advantageously, the composite membrane described herein selectively separates gaseous components from a gas/gas, gas/liquid, or liquid/liquid mixture without compromising the mechanical, compression and tensile strength of the composite membrane. The combination of the inorganic porous material and the 2D material demonstrates a compression strength of up to 12.0 MPa, flexural strength of up to 5 MPa and Young's modulus of up to 5,500 GPa, thereby allowing the continuous use of the composite membrane for 2 weeks or more without any decrease in the separation efficiency of the composite membrane.

In another aspect, there is provided a separation device comprising an upper enclosed chamber configured to receive a gaseous component; a lower enclosed chamber in fluid communication with the upper chamber and configured to receive a fluid stream comprising at least one gaseous component, said upper and lower chambers being partitioned by at least one composite membrane, wherein the composite membrane is configured to allow passage of said gaseous component from the lower chamber to the upper chamber, and wherein said composite membrane comprises an inorganic porous material and at least one two-dimensional (2D) material

The composite membrane in the separation device advantageously enables the separation of gaseous components without contact of the fluid stream or mixture with the membrane, which advantageously prevents the fouling of the membrane during the separation process and improves the lifetime of the membrane. The diffusion of gaseous components without contacting the fluid stream may be driven by a concentration gradient of the gaseous component, or the partial vapor pressure difference, across the membrane. In particular, the higher partial vapor pressure from the lower chamber, which receives the fluid stream, drives the diffusion of the gaseous component to the upper chamber, having a lower partial pressure of the gaseous component. The composite membrane which partitions the upper and lower chamber advantageously allows passage of gaseous components with higher affinity to the composite membrane.

Further advantageously, two-dimensional material in combination with inorganic porous material provides improved selectivity for the gaseous components to be removed from the gas/gas, gas/liquid, or liquid/liquid mixtures to produce a retentate stream that is substantially devoid of the separated gas components and provide structural strength and wear resistance that allows the composite membrane to be employed in scaled-up industrial operations.

In another aspect, there is provided a separation apparatus comprising a plurality of separation devices as described herein, wherein the plurality of separation devices may be operated in series or operated to receive a fluid stream from a common feedstock.

### Definitions

The following words and terms used herein shall have the meaning indicated: The term ‘2D materials’. ‘two-dimensional materials’, and grammatical variants thereof is to be interpreted broadly to include materials that comprise a single layer, few layers, and multi-layers of atoms. Non-limiting examples of such materials include transition metal dichalcogenides, graphene (e.g. nanoplatelets (GNP), graphene oxide (GO), reduced graphene oxide (rGO)), hexagonal boron nitride materials or combinations thereof.

The term “porosity” and grammatical variants thereof refers to measuring the empty spaces, channels, or voids in a material. The porosity of the material may be expressed as the volume fraction of voids over the total volume of the material.

The term “homogeneous” as used herein refers to substances that comprise components or elements which are the same. The term also refers to mixtures that contain a uniform distribution of multi-components throughout. Homogeneous mixtures may have the same composition of components or elements throughout. As described herein, homogeneous mixtures may contain one phase of matter, e.g. only liquid, solid or gas.

The term “pore size” as used herein refers to the diameter of a substantially round or spherical pore. The pores described herein may be of a regular or irregular shape. Regular shaped pores may be spherical, cylindrical, oblong or ellipse. Where the pores are not spherical in shape, the particle diameter shall be taken to be the longest measured diameter of the pore.

The term “organic material” or “organic matter” or grammatical variants thereof is to be interpreted to refer to hydrocarbon-based material or matter, which may be optionally substituted with other elements.

The term “laminate” or grammatical variants thereof refer to an overlay of material over a surface, which may be flat. “Laminated” materials may therefore comprise multiple layers of materials (i.e. multi-layer materials), wherein the layers may be of the same material or a different material.

The word “substantially” does not exclude “completely”, e.g. a composition that is “substantially free” from Y may be completely free from Y. Where necessary, the word “substantially” may be omitted from the definition of the invention.

Unless specified otherwise, the terms “comprising” and “comprise”, and grammatical variants thereof are intended to represent “open” or “Inclusive” language such that they include recited elements but also permit the inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges.

Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also forms part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1A is a three-dimensional (3D) illustration of the external structure of the separation device.

FIG. 1B is a 3D illustration of the cross-section of the separation device.

FIG. 1C is a cross-sectional view of the separation device showing the internal units as well as liquid and gas stream flow.

FIG. 2 is a cross-sectional view of the separation device showing the dimensions of separation device VPM-01 in millimeters.

FIG. 3 is a 3D schematic illustration of the lower chamber of the separation device VPM-01.

FIG. 4 is a 3D schematic illustration of the upper chamber of the separation device VPM-01.

FIG. 5 is a schematic illustration of supporting bars for the composite membrane in the separation device VPM-01.

FIG. 6 is a schematic illustration of a membrane metallic frame configured to position the composite membrane between the upper and lower chamber in separation device VPM-01.

FIG. 7A is a schematic illustration of a composite membrane fixed on a metallic frame.

FIG. 7B is a cross-sectional view of a composite membrane fixed on a metallic frame.

FIG. 8A is an image showing a metallic frame with a composite membrane fixed into said frame.

FIG. 8B is an image showing a lower chamber with supporting bars and metal frame mounted on the lower chamber.

FIG. 9 is a cross-sectional view of the side from which the feed and gas flow is provided to the separation device (top image), and a cross-sectional view of the front of the separation device showing the dimensions of the separation device VPM-02 in millimeters (bottom image).

FIG. 10A is a schematic illustration of the lower chamber of the separation device VPM-02.

FIG. 10B is a schematic illustration of the upper chamber of the separation device VPM-02.

FIG. 11A is a scanning electron micrograph (SEM) of a 2D material laminated on a surface of an inorganic porous material.

FIG. 11B is a scanning electron micrograph (SEM) of a 2D material laminated on a surface of the inorganic porous material having 2D material homogeneously dispersed therein.

FIG. 11C is a scanning electron micrograph (SEM) of the composite membrane based on a combination of an inorganic porous material and 2D material.

### DESCRIPTION OF THE EMBODIMENTS

Exemplary, non-limiting embodiments of a composite membrane, a separation device comprising the composite membrane, a separation apparatus comprising at least one separation device, and methods for the separation of gas/gas or liquid/gas mixtures according to the present invention shall be further disclosed in the following. Methods of preparing the composite membrane as described herein are also disclosed.

In one aspect, there is provided a composite membrane comprising at least one two-dimensional material and an inorganic porous material. The composite membrane may consist essentially of, or consist of, at least one two-dimensional material and an inorganic porous material. The composite membrane may be housed within a separation device adapted for the separation of gas/gas, liquid/gas, or liquid/liquid mixtures.

In another aspect, there is provided a separation device comprising one or more composite membranes, a lower enclosed chamber, and an upper enclosed chamber. The composite membrane may partition the lower and upper enclosed chambers and may be configured to allow only the selective passage of said gaseous component from the lower chamber to the upper chamber. The lower chamber may be configured to receive a fluid stream (feed) comprising at least one gaseous component. The upper chamber may be configured to receive a selected gaseous component (permeate).

The separation device described herein may be used in an industrial process for the separation of gases, liquids, and mixtures thereof comprising at least one liquid and/or at least one gas component. In particular, the composite membrane may be configured to allow passage of at least one gaseous component. This may be achieved by providing a composite membrane comprising an inorganic porous material and at least one two-dimensional material as described herein.

The inorganic porous material may comprise any material which possesses a crystalline, amorphous, or particulate structure. The inorganic porous material may be a hydrophilic inorganic porous material. The inorganic porous material may be made of inorganic materials which are typically utilized in the engineering field. Advantageously, the use of inorganic porous materials which are readily available allows the composite membrane to be scaled up for industrial use in a cost-effective manner.

Suitable inorganic porous material may comprise microporous, mesoporous, nanomaterials, nanocomposite, or nanostructured composite materials which possess a crystalline, semi-crystalline, amorphous, or particulate structure. Such inorganic porous materials may comprise interstices or pores through which a gas, liquid or vapor may pass through. The inorganic porous material may preferentially allow passage of specific gaseous compounds, e.g. ethanol, methanol, carbon dioxide, etc., when used in combination with 2D materials.

The inorganic porous material may be subjected to physical and/or chemical pre-treatments prior to the preparation of the composite membrane. These pre-treatments may include one or more steps of grinding, calcination, sintering, confined pressure compaction, or activation with water or organic solvents. In embodiments, the inorganic porous material may be activated with water for the preparation of the composite membrane.

The inorganic porous material may comprise silicates, engineered ceramics, metals, or a combination thereof. Exemplary silicates may include, but are not limited to kaolinite, smectite, nontronite, saponite, montmorillonite, illite, chlorite, vermiculite, talc, pyrophyllite, zeolite, borosilicate, or mixtures thereof. Engineered ceramics may include alumina, beryllia, ceria, zirconia, tungsten carbide, silicon carbide, carbides, borides, nitrides, silicides, titania, or mixtures thereof. Metals or powder metallurgy materials may include iron, steel, stainless steel, copper, aluminium, tin, magnesium titanium, tungsten, or mixtures thereof. Such metallurgy materials may be sintered or cast in an inert atmosphere to obtain a porous structure.

For instance, natural zeolites such clinoptilolite, chabazite, phillipsite, mordenite, and synthetic zeolites such as zeolite A, zeolite, beta, zeolite Y. ZSM-5 may be used in the composite membrane described herein.

The inorganic porous material may be selected from a group consisting of ceramics (i.e. engineered ceramics), clays, gypsum, hydroxyapatite, industrial ceramics, powder metallurgy materials, silicates, zeolites and combinations thereof. In an embodiment, the inorganic porous material comprises gypsum, i.e. CaSO₄·2H₂O.

Advantageously, the combination of gypsum and the 2D materials yielded a composite membrane which demonstrates selectivity in separating mixtures comprising gases. In particular, the combination of gypsum and the 2D materials described herein provides a composite membrane with sufficient pore size to facilitate selective passage of specific gaseous components in the mixture while maintaining a compression strength of between 7.5 to 12 MPa, flexural strength of between 2.5 and 5 MPa and Young's modulus of between 500 to 5500 GPa. The polarity of gypsum, when used in the composite membrane, is also believed to contribute to the transport of polar gaseous components across the membrane.

Further advantageously, composite membranes comprising gypsum may be used continuously for 2 months or more while maintaining the separation efficiency of the composite membrane throughout its use. This feature may be attributed to the strength of the composite membrane described herein, which remains unaffected by the diffusion of gaseous components through the composite membrane.

The Inorganic porous material may be provided at about 70 wt. % to 99.9 wt. %, based on the total weight of the composite membrane. For example, the inorganic porous material may be provided at 72 wt. % to 99.9 wt. %, or from 74 wt. % to 99.9 wt. %, or from 76 wt. % to 99.9 wt. %, or from 78 wt. % to 99.9 wt. %, or from 80 wt. % to 99.9 wt. %, or from 82 wt. % to 99.9 wt. %, or from 84 wt. % to 99.9 wt. %, or from 88 wt. % to 99.9 wt. %, or from 88 wt. % to 99.9 wt. %, preferably from 89 wt. % to 99.9 wt. %, even more preferably from 89 wt. % to 99.8 wt. %, based on the total weight of the composite membrane. In embodiments, the inorganic porous material content is 89.75 wt. %, 93.85 wt. %, 94.00 wt. % and 99.75 wt. %.

The inorganic porous material may be chemically bonded or physically adhered to a two-dimensional material during the preparation of the composite membrane. The composite membrane may comprise a single two-dimensional material or a mixture of two or more two-dimensional materials. The 2D material may be homogeneously dispersed within the inorganic porous material and/or laminated onto at least one surface of the inorganic porous material. The composite membrane may therefore comprise a homogenous dispersion of the two-dimensional material within the inorganic porous material or an inorganic porous material wherein at least one surface is a laminate of two-dimensional material or a combination thereof. For example, the composite membrane may comprise a 2D material laminated over at least one surface of the inorganic porous material having a homogenous dispersion of a 2D material therein.

The two-dimensional materials that may be added to the composite membrane may include graphene oxide, graphene nanoplatelets, reduced graphene oxide, molybdenum disulfide, hexagonal boron nitride, phosphorene, transition metal dichalcogenides, xenes or mixtures thereof. In embodiments, the two-dimensional material may be graphene oxide, graphene nanoplatelets or a mixture of graphene nanoplatelets and graphene oxide.

The physical and chemical properties of the two-dimensional materials, such as interlayer distance, surface charge and interlocked structure of the laminates, may be exploited for the preparation of the composite membrane. The intrinsic nanostructures, e.g. nanopores, nanolayers or nanochannels of the 2D material, in combination with the porosity of the inorganic porous material, may provide a composite membrane that advantageously demonstrates selectivity for specific gaseous components. In addition, the chemical and physical stability of the inorganic porous material and the 2D material advantageously allows the industrial scale preparation of the membrane.

The hydrophilicity, hydrophobicity or organophilicity of the composite membrane may be optimized using different two-dimensional materials, based on the specific gaseous component to be separated. In particular, the 2D materials may be selected to optimize the composite membrane's hydrophilicity, hydrophobicity or organophilicity to tune and enable the passage of gaseous components with higher affinity to the composite membrane.

In embodiments, the two-dimensional material may be selected to tune the organophilicity of the composite membrane. Advantageously, organic compounds such as butanol were separated by incorporating only about 0.25 wt. % of a 2D material to the composite membrane. The separation of organic components may be due to the hydrophobic nature of the graphene nanoplatelet materials, which were incorporated in the composite membrane, allowing the passage of gaseous components with affinity to the composite membrane, such as butanol.

The content of the two-dimensional material may be selected to separate specific gaseous components in a gas/gas or gas/liquid mixture. The two-dimensional material may comprise about 0.1 to 20 wt. % of the total weight of the composite membrane. It is to be understood that the description of the weight and weight ratios of the two-dimensional material refers to the total weight of the two-dimensional material in the composite membrane, where more than one two-dimensional material is used. The composite membrane may comprise a two-dimensional material content ranging from about 0.1 wt. % to 18 wt. %, or from about 0.1 wt. % to 16 wt. %, or from about 0.1 wt. % to 14 wt. %, or from about 0.1 wt. % to 12 wt. %, or from about 0.1 wt. % to 11 wt. %, preferably from about 0.2 wt. % to 10.5 wt. %, even more preferably from about 0.25 wt. % to 10 wt. %. In embodiments, the content of two-dimensional material may be about 0.25 wt. %, about 6 wt. %, about 6.15 wt. %, or about 10.25 wt. %.

Advantageously, the composite membrane comprising about 0.25 wt. % to 10.5 wt. % of the two-dimensional material demonstrated selectivity toward specific components in a gas/gas, gas/liquid, or liquid/liquid mixtures, resulting in a permeate that is substantially free of the specific gaseous component. In particular, it was found that by maintaining two-dimensional material content at about 0.25 wt. % to 10 wt. % of the composite membrane, separation of gaseous components having molecular weights of up to 100 g/mol, preferably up to 75 g/mol, was achieved. For example, selective separation of butanol from a butanol/water mixture was achieved with a composite membrane having a 2D material content of only 0.25 wt. %

Further advantageously, by maintaining a two-dimensional material content of about 10.25 wt. % in the composite membrane, selective separation of molecules as small as water from a water/ethanol mixture may be achieved, yielding a retentate that is substantially free of water.

The selective separation of the composite membrane may be attributed to the combination of the intrinsic nanostructures of the 2D material in combination with the porosity of the inorganic porous material.

The weight ratio of the two-dimensional material to the inorganic porous material may also be selected to preferentially allow for the separation of specific gas components in a gas/gas or gas/liquid mixture without compromising the mechanical and flexural strength of the composite membrane. The weight ratio of the two-dimensional material to the inorganic porous material may range from about 1:5 to about 1:500, or from about 1:5 to about 1:480, or from about 1:5 to about 1:460, or from about 1:5 to about 1:440, or from about 1:5 to about 1:420, or from about 1:5 to about 1:400, or from about 1:6 to about 1:400, or from about 1:7 to about 1:400, or from about 1:8 to about 1:400, or preferably from about 1:9 to about 1:400. In one embodiment, the weight ratio of the two-dimensional material to the inorganic porous material is about 1:400.

The two-dimensional material and the inorganic porous material may also be provided at a weight ratio of about 1:5 to about 1:350, or from about 1:5 to about 1:300, or from about 1:5 to about 1:250, or from about 1:5 to about 1:200, or from about 1:5 to about 1:150, or from about 1:5 to about 1:100, or from about 1:5 to about 1:50, or from about 1:5 to about 1:40, or from or from about 1:5 to about 1:30, or from about 1:5 to about 1:20, or from about 1:5 to about 1:18, or from about 1:6 to about 1:18, or from about 1:8 to about 1:18, or from about 1:9 to about 1:18, or from about 1:9 to about 1:16. In other embodiments, the composite membrane comprised a weight ratio of two-dimensional materials to inorganic porous material of about 1:9, about 1:15, or about 1:16.

The inorganic porous material and two-dimensional material content may be selected to provide a composite membrane having a pore size that allows for the preferential passage or permeation of gas vapors. The composite membrane may comprise an inorganic porous material and two-dimensional material content, which provides an average pore size of between 0.1 μm to 50 μm. The average pore size or pore size of the composite membrane may be from about 0.1 μm to 50 μm, or about 0.1 μm to 45 μm, or about 0.1 μm to 40 μm, or about 0.1 μm to 35 μm, or about 0.1 μm to 30 μm, or about 0.1 μm to 25 μm, or about 0.1 μm to 20 μm, or about 0.1 μm to 15 μm, or about 0.5 μm to 15 μm, or about 0.5 μm to 12 μm, or preferably about 0.5 μm to 10 μm. In embodiments, the pore size of the composite membrane ranges between about 0.5 μm to 3 μm, about 1 μm to 3 μm, about 0.5 μm to 3 μm or about 1 μm to 10 μm.

Advantageously, transport of the gaseous components in a gas/gas, gas/liquid, liquid/liquid mixtures may be facilitated by maintaining the pore size of the composite material within the range of about 0.5 μm to 10 μm. In particular, where composite membranes with a pore size of 0.5 μm to 10 μm are provided, capillary forces may be utilized to facilitate the continuous transport of gaseous components through the composite membrane. The combination of the pore size of the composite material and the properties of the 2D material advantageously provides continuous, selective transport of gaseous components across the composite membrane.

The composite membrane composition described herein may be optimized to provide sufficient porosity for separating gases/vapors from a mixture of gases and/or liquids. The porosity of the membrane may be about 10-30% of the volume of the membrane. This may include composite membranes having a porosity of about 12 to 30%, or about 14 to 30%, or about 16 to 30%, or about 18 to 30%, or about 20 to 30%, or about 22 to 30%, or about 24 to 30%, or about 26 to 30%, or preferably about 26 to 28% of the volume of the membrane. In embodiments, the composite membrane has a porosity of about 27% of the volume of the membrane.

The composite membrane described herein may be substantially free of any detectable quantity of organic material or organic matter. As such, the composite membrane, including the inorganic porous material and two-dimensional material, may be substantially free of functionalization with organic molecules. It is to be understood that the terms “organic material” or “organic matter” used herein refer to compounds based on a hydrocarbon framework or backbone, which may be polar or non-polar, and optionally functionalized with other atoms, including, but not limited to nitrogen, chlorine, fluorine, bromine and the like. However, this does not preclude the use of organic solvents for the preparation of such membranes.

The composite membrane may be positioned at the partition between the upper and lower chambers of the separation device provided herein. The thickness, shape and size of the membrane may be adapted based on the dimensions of the separation device and the scale of separation which is to be performed. The membrane described herein may be prepared with a thickness suitable for industrial-scale separation of gas/gas or liquid/gas mixtures. For example, the composite membrane may be prepared with a thickness of about 1 mm to 10 mm, or about 1 mm to 9 mm, or about 1 mm to 8 mm, or about 1 mm to 7 mm, or about 1 mm to 6 mm, or about 2 mm to 6 mm, or about 3 mm to 6 mm, or preferably about 3 mm to 5 mm. In embodiments, the thickness of the composite membrane may be about 3 mm or 5 mm.

Advantageously, using the inorganic porous material in combination with the 2D material may confer mechanical strength (compression and tension strength) to the composite membrane, thereby improving the lifetime (i.e. duration before replacement of the membrane is required). When provided as a flat sheet, the composite membrane described herein may demonstrate a Young Modulus of between 3.500 and 5,500 GPa, compression strength between 7.5 and 12.0 Mpa, and flexural strength between 2.5 and 5 Mpa. The strength of the composite membrane may also be observed from the maximal deformation of the membrane under work conditions, which may be about 30 μm.

Further advantageously, the separation efficiency of the composite membranes was maintained even after continuous use for up to two months, which may be attributed to the strength and durability of the composite membranes described herein.

The surface area of the composite membrane may be selected according to the scale of the industrial separation. For instance, the surface area of the composite membrane may be in the range of from about 0,001 m² to about 1 m², or about 0.002 m² to about 1 m², or about 0.003 m² to about 1 W or about 0.004 W to about 0.8 m², or about 0.001 m² to about 0.6 m², or about 0.004 m² to about 0.6 m², or about 0.005 m² to about 0.6 m², or about 0.005 m² to about 0.5 m², or preferably about 0.005 m² to about 0.45 m². In embodiments, the composite membrane fabricated for the separation device is prepared with a surface area of about 0.0058 m², or about 0.44104 m².

The shape and size (i.e. dimensions) of the separation device may also be adapted according to the separation scale to be performed. The separation device's length, width, and height may be optimized to provide a volume sufficient to perform the industrial-scale separation. For instance, the separation device may be prepared with a length sufficient to allow a gaseous component to contact and pass through the composite membrane as a fluid stream of a gas/gas or liquid/gas mixture is passed through the lower chamber. The depth of the separation device, particularly the lower chamber, may also be sufficient to allow the permeation of a gaseous component while avoiding contact with the composite membrane.

The volume of the device's upper and lower chambers may be adapted to perform the industrial-scale separation of up to 0.01 m³ or 10 L. The upper chamber and lower chamber may be of equal or different volumes. The lower chamber may be adapted to allow the separation of gas and/or liquid mixtures without the contact of the liquid stream with the composite membrane that partitions the upper and lower chambers. For example, the volume of the upper and lower chambers of the separation device may be, independently in the range of about 70 cm³ to 0.01 m³, or about 70 cm³ to 0.008 m³, or about 70 cm³ to 0.007 m³, or about 70 cm³ to 0.006 m³, or about 70 cm³ to 0.005 m³, or about 70 cm² to 0.004 m³, or about 70 cm³ to 0.003 m³, or about 80 cm³ to 0.003 m³, or about 80 cm³ to 0.0025 m³, or preferably about 90 cm³ to 0.0025 m³. In one embodiment, the separation device is prepared with an upper and lower chamber having an equal volume of about 96 cm³. In another embodiment, the volume of the upper chamber of the separation device is about 0.00135 in, while the volume of the lower chamber is 0.00225 m³.

The upper chamber of the separation device may further comprise an outlet for discharging the gaseous component from the upper chamber. The outlet may be optionally connected to a condensation unit to collect the separated gaseous component in the liquid phase. The discharge of the gaseous component from the upper chamber may also be facilitated by supplying a flow of inert gas or dry air to the upper chamber through an inlet. The inert gas may be nitrogen or argon.

The upper and lower chambers of the separation device may be configured to withstand high pressures resulting from the flow of the fluid stream and the passage of the gaseous component through the membrane, in addition to the gas flow provided to the upper chamber. In embodiments, the upper and lower chamber may be configured to withstand process pressures of up to 10 bar. For example, the upper and lower chambers may be configured to withstand a process pressure of up to 2 bar, up to 5 bar or up to 8 bar. The materials used to manufacture the upper and lower chamber may be any material sufficient to withstand the process pressure.

The composite membrane described herein may be fabricated separately and subsequently positioned on a membrane frame adapted to provide mechanical support to the membrane. Alternatively, the composite membrane may be fabricated directly on the membrane frame. The membrane frame may be positioned at recesses provided in the lower chamber of the separation device. Optionally, supporting bars or meshes may provide additional mechanical support to the membrane frame.

A sealing means may be provided between the components of the separation device, for example, between the upper and lower chambers, to provide a leak-proof separation device. The sealing means may be a gasket, preferably a flat rubber gasket, which may be provided between the membrane metal frame and the inner edge of the lower chamber. A sealing means may also be provided between the upper and lower chambers to provide a leak-proof separation device. The sealing means may also include nuts and bolts which secures the upper and lower chambers.

The lower chamber may be configured to receive a steady flow of a fluid stream for liquid/liquid, liquid/gas or gas/gas separation to be carried out. In particular, the lower chamber may be provided with an inlet for supplying the fluid stream to the lower chamber for the separation. The inlet may be connected to a pump configured to provide a steady fluid stream comprising at least one gaseous component. The lower chamber may also comprise an outlet for discharging the retentate fluid stream. Preferably, the fluid stream discharged from the separation device may be substantially free or devoid of the gaseous permeate.

The separation devices described herein may be provided in a separation apparatus for liquid/liquid, liquid/gas or gas/gas separation to be performed on an industrial scale. In one aspect, there is provided with a separation apparatus comprising a plurality of separation devices as described herein, which may be operated in series or operated to receive a fluid stream from a common feedstock. For instance, a series of separation devices may be connected to a feedstock tank which supplies a fluid stream through the lower chamber of the separation device.

A method of preparing the composite membrane is also provided herein. The method may comprise the steps of (a) contacting a dispersion of a two-dimensional material with an inorganic porous material or a precursor thereof, and (b) drying the mixture obtained from step (a).

The two-dimensional material, inorganic porous material, or inorganic porous material precursor may be provided as a liquid dispersion or suspension in a solvent. The step of contacting a dispersion of a two-dimensional material with an inorganic porous material or a precursor thereof may comprise mixing a liquid dispersion of the two-dimensional material with the inorganic porous material or a precursor thereof to provide a homogenous mixture. The resultant composite membrane may comprise a homogenous dispersion of the two-dimensional materials within the inorganic porous material.

The suspension of the inorganic porous material precursor may be prepared by solvent activation of the precursor. For example, where the inorganic porous material comprises gypsum, a suspension of the inorganic porous material precursor may be prepared by activating calcium sulfate hemihydrate, CaSO₄·0.5H₂O, in water. Activation of the precursor in a solvent may be carried out by mixing of the precursor with water or an aqueous solution, preferably water.

The mass ratio of the solvent, preferably water, to the inorganic porous material or a precursor thereof may range from about 1:1 to about 1:5, or about 1:1 to about 1:4.5, or about 1:1 to about 1:4, or about 1:1 to about 1:3.5, or about 1:1 to about 1:3, or about 1:1 to about 1:2.5, or about 1:1 to about 1:2, or about 1:1.2 to about 1:2, or preferably about 1:1.2 to about 1:2, more preferably about 1:12 to about 1:1.8, even more preferably about 1:1.2 to about 1:1.5. In embodiments, where the inorganic porous material comprises gypsum. i.e. CaSO₄·2H₂O, an aqueous suspension of the inorganic porous material is prepared by adding the precursor CaSO₄0.5H₂O to water at a mass ratio of about 10:7.

The aqueous dispersion of the two-dimensional material may be prepared by mixing an appropriate amount of the two-dimensional material with the aqueous solution. The composite membrane may be prepared from an aqueous dispersion of the two-dimensional material and an aqueous suspension of the inorganic porous material or a precursor thereof, provided at a volume ratio of 1:1 to 1:20. The volume ratio of the aqueous dispersion of the two-dimensional material and the suspension of the inorganic porous material or a precursor thereof may be about 1:1 to about 1:20, or about 1:1 to about 1:18, or about 1:1 to about 1:16, or about 1:1 to about 1:15, or about 1:1 to about 1:14, or about 1:1 to about 1:12, or preferably about 1:1 to about 1:10.

Where a composite membrane comprising 0.1 wt. % to 15 wt. % of two-dimensional material is desired, the volume ratio of the aqueous dispersion of the two-dimensional material and a suspension of the inorganic porous material or a precursor thereof may be about 1:1. Composite membranes comprising less than 1 wt. % of two-dimensional material may be provided with an aqueous dispersion of the two-dimensional material and a suspension of the inorganic porous material or precursor thereof at a weight ratio of about 1:2 to about 1:10.

Alternatively, contacting step (a) may comprise casting a liquid mixture of the two-dimensional material over a surface of an available or prepared inorganic porous material. Composite membranes prepared by such methods may comprise a two-dimensional material laminated over the inorganic porous material. The inorganic porous material may be provided as a flat sheet with a desired thickness prior to casting the two-dimensional material's liquid dispersion. Preferably, the inorganic porous material may be provided as a flat, solid sheet having a thickness ranging from 1 mm to 10 mm.

The inorganic porous material may also be prepared from an inorganic porous material precursor shortly before casting the liquid mixture of the two-dimensional material. This may be carried out by pouring a suspension of the inorganic porous material precursor into a mold and allowing the suspension to solidify by drying at room temperature.

Optionally, a liquid dispersion of the 2D material may be cast on at least one surface of an inorganic porous material having a homogenous dispersion of a 2D material therein. Composite membranes prepared by such methods may therefore comprise a layer of a 2D material laminated over at least one surface of an inorganic porous material having a homogenous dispersion of a 2D material therein. The 2D material in the laminate layer may be the same or different from the 2D material, which is homogeneously dispersed within the inorganic porous material.

In embodiments, a liquid dispersion of a second 2D material is cast over the surface of an inorganic material comprising a first 2D material homogeneously dispersed therein. The second 2D material may be the same or distinct from the first 2D material.

The dispersion of the two-dimensional material may be prepared by mixing a dry powder of the two-dimensional material in an aqueous system. The aqueous solution may be water or a basic solution. For example, basic solutions comprising NH₄OH, NaOH, KOH or mixtures thereof, provided at concentrations of 0.1 M to 0.5 M may be used for the dispersion of the two-dimensional material. The concentration of the resultant dispersion of two-dimensional material may range from about 1 g/L to 10 g/L. Optionally, the dispersion of the two-dimensional material may be subjected to mid sonication of the aqueous dispersion for a sufficient amount of time, e.g. 1 hour. In embodiments, the composite membrane was prepared using 1 g/L, 2 g/L, 2.5 g/L and 5 g/L dispersions of the 2D material in 0.1 M and 0.5 M basic solutions.

The mixture of the two-dimensional material and the inorganic porous material precursor or inorganic porous material may subsequently be dried to form the solid composite membrane. The drying step may be performed by leaving the mixture at room temperature for a duration sufficient to remove residual solvent. In some embodiments, composite membranes prepared from the casting of the dispersion of two-dimensional material on a surface of the inorganic porous material may be left to dry at room temperature for a period of 24 hours to yield the composite membrane. A thermal treatment may optionally be carried out on the dried composite membrane.

The step of drying the mixture of the two-dimensional material and the inorganic porous material precursor or inorganic porous material may also be carried out by low-temperature sintering or calcination. In embodiments, where a homogenous mixture of the two-dimensional material and the inorganic porous material precursor is prepared, the mixture may be poured into a mold of a desired shape and size and dried at room temperature for a duration of 24 hours before being subjected to thermal treatment.

Where thermal treatment of the composite membrane is performed, the composite membrane may be subjected to elevated temperatures for a duration, which is sufficient to remove residual solvent or residual water from the composite membrane. For example, the composite membrane may be subjected to thermal treatment in an oven at a temperature of 25° C. to 80° C. for 1 to 18 hours.

The composite membrane may also be subjected to calcination at temperatures of 300° C. to 600° C. for a sufficient time to remove any organic matter and residual solvent from the preparation of the membrane. For instance, the composite membrane may be calcined for a period of up to 10 hours.

The present disclosure also provides a method of separating mixtures comprising at least one gaseous component. The method may comprise passing a fluid stream comprising at least one gaseous component through a lower enclosed chamber of a separation device, wherein the lower closed chamber is in fluid communication with the upper chamber.

The lower chamber may be configured to receive a fluid stream comprising at least one gaseous component. The fluid stream may be provided at a liquid flow rate sufficient to allow a gaseous component from the fluid stream to permeate through a composite membrane which partitions the upper and lower chambers. For example, the fluid stream may be provided at a liquid flow rate of up to 30 liters per hour. The fluid stream may comprise a liquid mixture and at least one gaseous component or a mixture of two or more gases. In embodiments, the fluid stream is a gas/gas, liquid/liquid or liquid/gas mixture. Where liquids are present in the mixture to be separated, the fluid stream is provided to the lower chamber without contacting the composite membrane, which partitions the upper and lower chambers.

The method of separating a mixture may further comprise the step of allowing a gaseous component to permeate through the composite membrane described herein to an upper chamber configured to receive the gaseous component. The upper chamber may be provided with inert gas flow to discharge the gaseous component from the upper chamber for the collection unit, preferably at the condensation unit. The upper chamber may be configured to withstand vapor pressures resulting from the passage of the gaseous component and the flow of inert gas through the upper chamber.

The separation of the liquid may be performed at ambient temperature or may be performed at higher temperatures. As such, the upper and lower chambers of the separation device may be fabricated to withstand temperatures of up to 250° C. and pressures of up to 10 bar. Preferably, the separation of the liquid is performed at temperatures not exceeding 80° C., preferably at temperatures not exceeding 60° C., for example, at temperatures of 60° C., 45° C., 30° C. or ambient temperatures of 25° C. Advantageously, by performing the separation of gas-liquid mixtures at temperatures not exceeding 60° C., selective separation of gaseous components may be achieved while preventing any decomposition of constituents in the mixture. Low-temperature separation of gaseous components may be especially used for mixtures comprising temperature-sensitive materials and components.

It is envisioned that the disclosed composite membrane, separation device and separation apparatus may be coupled directly to process reactors to remove vapors, which may drive the chemical reactions to completion, thereby improving reaction yield and efficiency. This advantageously contributes to a reduction of energy consumption since chemical reactions may require a shorter duration to achieve optimal yield. The number of thermal isolating systems and materials typically employed for industrial processes may also be reduced since high-temperature separations may be avoided. Accordingly, the devices and separation apparatus described herein may be used to reduce the environmental impact of industrial processes.

### DETAILED DESCRIPTION OF DRAWINGS

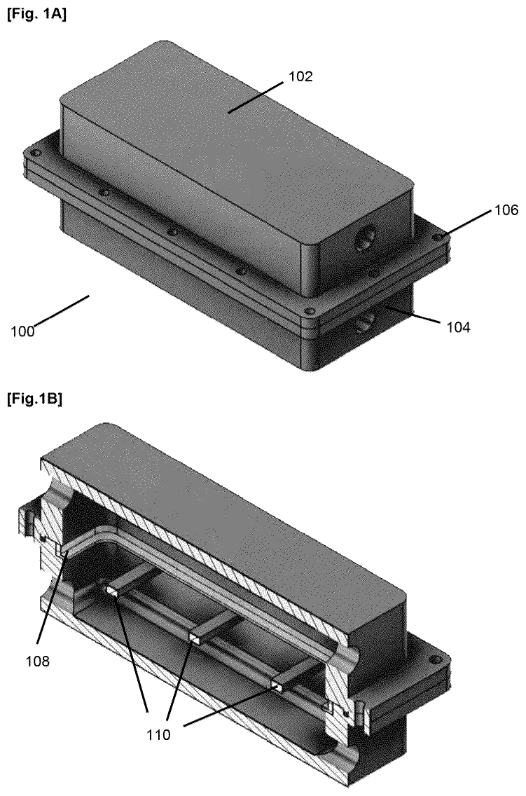

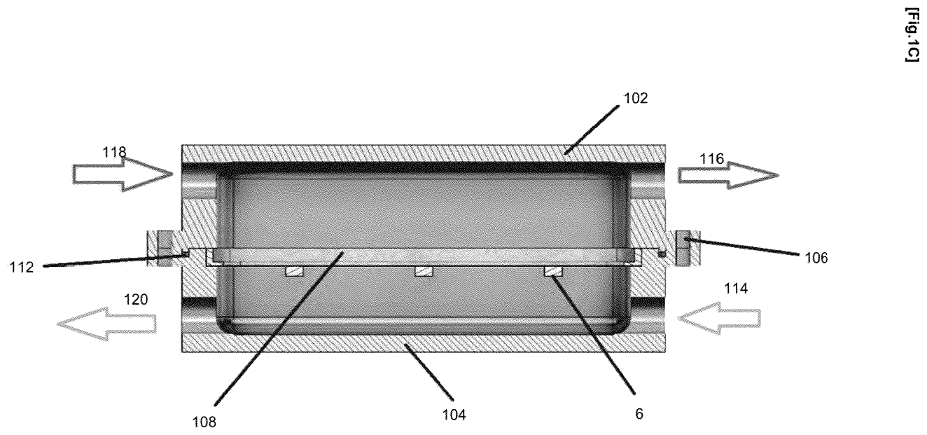

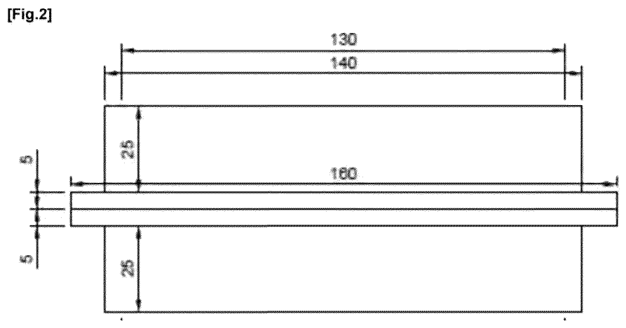

FIG. 1 provides a three-dimensional perspective view of a separation module (FIG. 1A), a perspective view of a cross-section of the separation module (FIG. 18) and a view of the cross-section of the separation module (FIG. 1C).

FIG. 1A shows an exemplary separation device 100, which comprises an upper chamber 102 and a lower chamber 104, wherein the two chambers are designed such that they can be joined together by nuts and bolts 106. The ends of the lower chamber are provided with an inlet and outlet to allow the flow of a fluid stream through the chamber. Likewise, the upper chamber is provided with an inlet and outlet located at opposite ends of the chamber to allow gas flow through the chamber to discharge the collected gaseous component.

FIG. 1B illustrates the internal structure of an exemplary separation device which may comprise a metallic frame 108 fitted on the upper portion of the lower chamber. Three support bars 110 may be placed parallel to and beneath the frame.

Referring to the cross-section of an exemplary separation device of FIG. 1C, a membrane mounted on the metallic frame 108 is sealed with a rubber gasket 112. To initiate the separation process, a fluid stream 114 comprising at least one gaseous component is first passed into the lower chamber 104 at a certain flow rate. Appropriate temperatures and pressures may be applied to the chamber to facilitate the passage of the gaseous component through the membrane into the upper chamber 102. The separated gaseous component may be collected from outlet 118. The fluid stream may be provided continuously through the lower chamber via a pump to ensure the continuous separation. In one embodiment, an inert gas stream 118 may be provided to the upper chamber 102 to facilitate the collection of the gaseous component. Outlet 116 may be connected to a condensation system. In another embodiment, a vacuum is applied to the upper chamber to extract and collect the gaseous component in a condensation system.

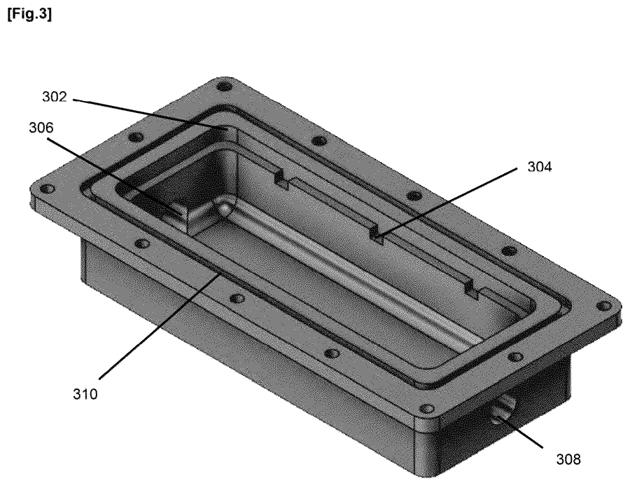

FIG. 2 is a schematic illustration of an exemplary separation device VPM-01. The device is designed to house a composite membrane of the dimensions of up to 126 mm (length)×46 mm (width)×5 mm (thickness). The separation device VPM-01 is designed according to the following specifications:
i. Materials used for both lower and upper chamber: grade 316 stainless steel (SS316)
ii. Materials for feed and retentate connectors: straight brass hose connector, ¼″ G male, ID ⅜″
iii. Permeate connector: ¼″ (11.07 mm) female national pipe thread (FNPT).
iv. Screws that connect the upper and lower chamber: 12×M4 nut and bolt with metal washers
v. Seal of membrane: flat rubber gasket.
vi. Overall dimensions of separation device: 160 mm (length)×80 mm (width)×60 mm (height)
vii. Dimensions of each chamber (FIG. 2): 140 mm (external length), 130 mm (internal length), 25 mm (depth), 60 mm (width)
viii. Metal plates that join the upper and lower chamber via the installation of nuts and bolts: 160 mm (length). 5 mm (height)
ix. Maximal processing pressure: 5 bar.
x. Maximal process temperature: 200° C.
xi. Vacuum: from 1 mbar to 1 bar, preferably 500 mbar
xi. Feed pump capacity: 10 liters per hour (LPH)

Referring to FIG. 3, the lower chamber is constructed from SS316 seamless metal bars with dimensions of 80 (length)×30 mm (width). The chamber may be formed from the bars by computer numerical control (CNC) machining. A recess 302 is provided to place membrane frame/slab of 5 mm thickness and 0.0058 m² area on top of the lower chamber. Recesses 304 may also be provided for supporting bars to be placed underneath and seamlessly to the metal frame. Flat rubber gaskets may be positioned on the periphery of the lower chamber at slot 310 to provide a leak-proof seal. The liquid withholds capacity of the lower chamber of VPM-01 is 0.000096 m³, i.e., 30-40 ml of liquid. The lower chamber is designed for continuous operation with a liquid flow rate of up to 10 LPH and an operating temperature up to 150° C. A straight brass hose connector, ¼″ G male, ID ⅜″ may be fitted on opposite ends (306 and 308) of the tower chamber to supply the liquid stream.

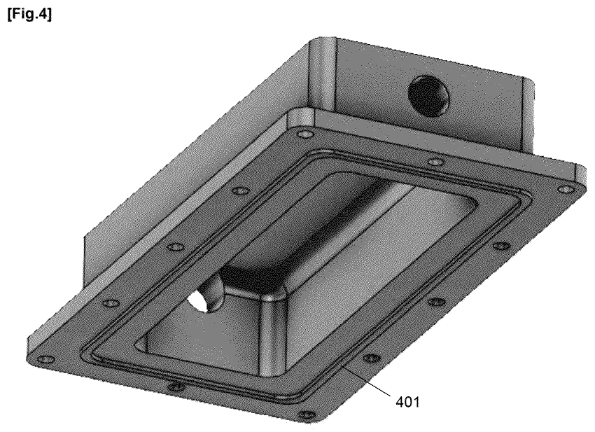

Referring to FIG. 4, the upper chamber is constructed from SS316 seamless metal bars with dimensions of 80×30 mm. The chamber is formed from the bars by CNC machining. The top chamber may comprise an extended gasket slot line 401 to seal the device against leaks, which is in contact with the flat rubber gasket at the lower chamber. The gas withholds capacity is of the upper chamber 0.000096 m³. The upper chamber is designed for continuous operation with a gas flow rate of up to 5 LPM and an operating temperature up to 150° C. ¼″ FNPT is fitted on opposite sides of the upper chamber for gas tube connection.

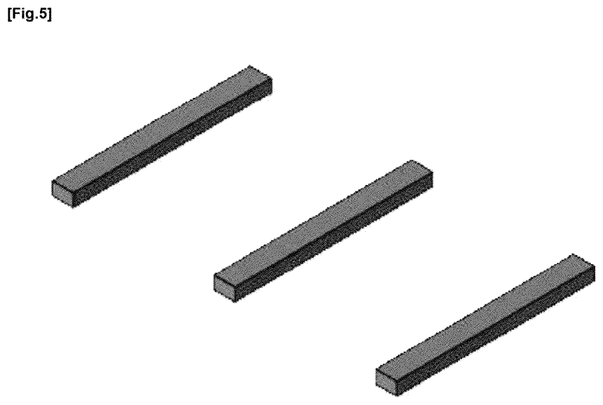

Referring to FIG. 5, supporting bars/mesh may be constructed from SS316 seamless 46×5×3 mm metal bars using CNC machining. The support is used to provide additional mechanical sustenance to the membrane metal frame or membrane slab.

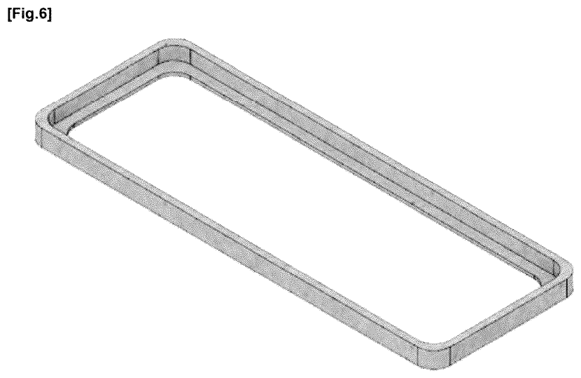

Referring to FIG. 6, a membrane frame is constructed from SS316 seamless 126×46×5 mm metal bars, using CNC machining. This frame is used to provide additional mechanical support to the flat membrane slab, which may be directly fabricated onto it. It also provides leak-proof during module operation under elevated operating conditions such as the increase of temperature or pressure.

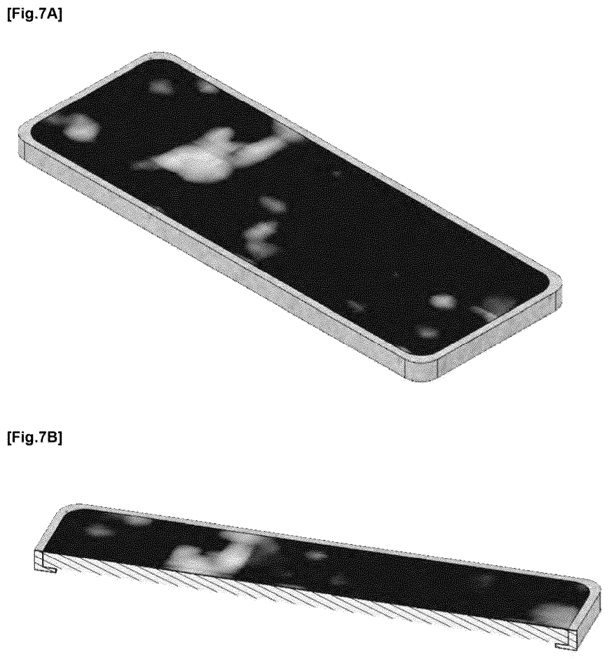

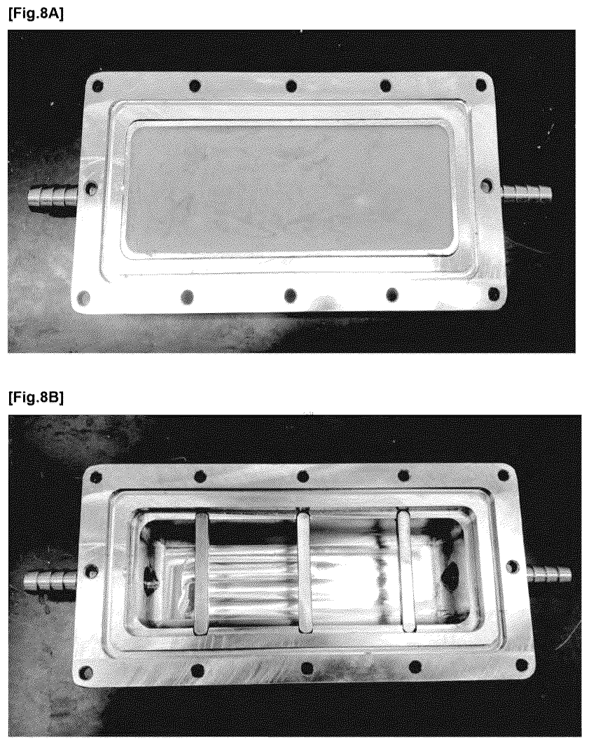

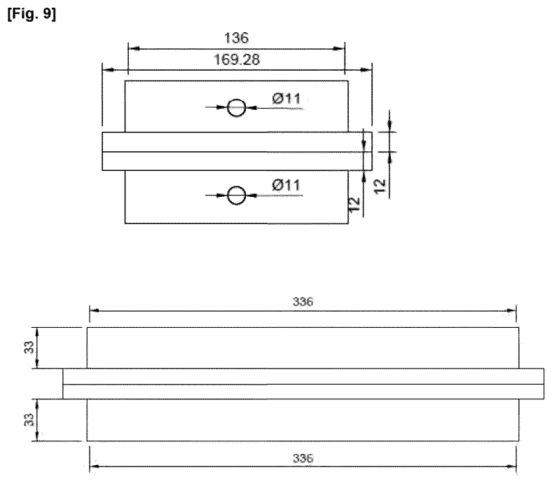

Referring to FIG. 7, a membrane may be fixed into the metal frame for mounting in the separation device. The metal frame may be positioned in the lower chamber, as shown in FIG. 8. The flat rubber gasket may be placed into the slot around the lower chamber to provide a leak-proof separation device. The device may be closed by positioning the upper chamber on of the lower chamber and sealing it with nuts and bolts along with a metal washer to provide tolerance.

FIG. 9 is a schematic drawing of an exemplary separation device VPM-02, designed for large-scale separation processes, which is similar to the design and structure of VPM-01. Separation device VPM-02 is designed to house a composite membrane with a size of up to 298 mm (length)×148 mm (width)×10 mm (thickness). The device is designed with the following specifications:
i. Materials used for both lower and upper chamber: SS316
ii. Materials for feed and retentate connectors: straight brass hose connector, ¼″ G male, ID ⅜″
iii. Permeate connector: ¼″ (11.07 mm) female national pipe thread (FNPT).
iv. Screws that connect the upper and lower chamber; 12×M4 nut and bolt with metal washers
v. Seal of membrane: flat rubber gasket.
vi. Overall dimensions of separation device: 400 mm (length)×169.28 mm (width)×90 mm (height)
vii. Dimensions of each chamber (FIG. 9): 336 mm (length), 33 mm (depth), 136 mm (width)
viii. Metal plates that connect both upper and lower chamber via the installation of nuts and bolts (FIG. 9): 400 mm (length), 12 mm (height), 169.28 mm (width)
ix. Max. process pressure: 2 bar
x. Max. process temperature; Dependent on membrane type
xi. Vacuum: from 1 mbar to 1 bar, preferably 10 mbar.
xii. Feed pump capacity: 25 LPH

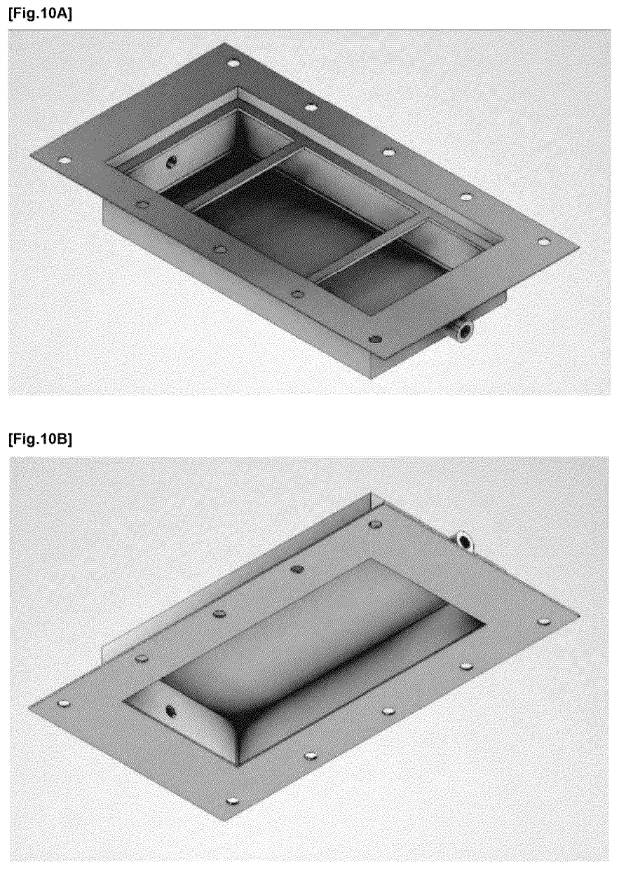

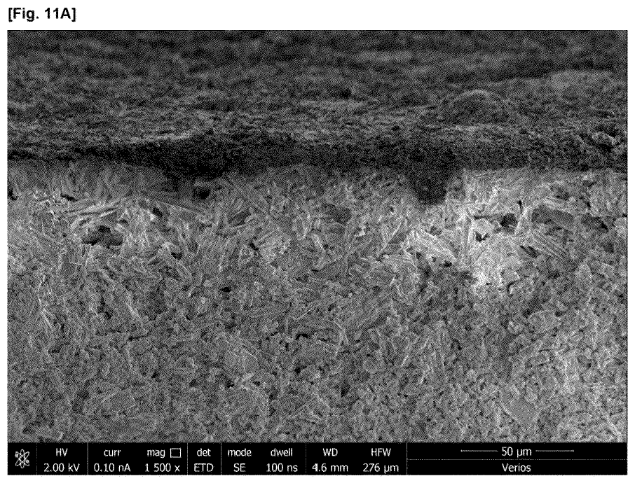

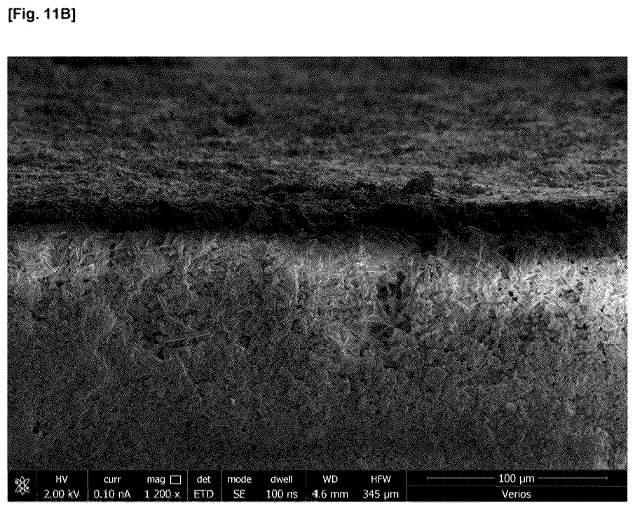

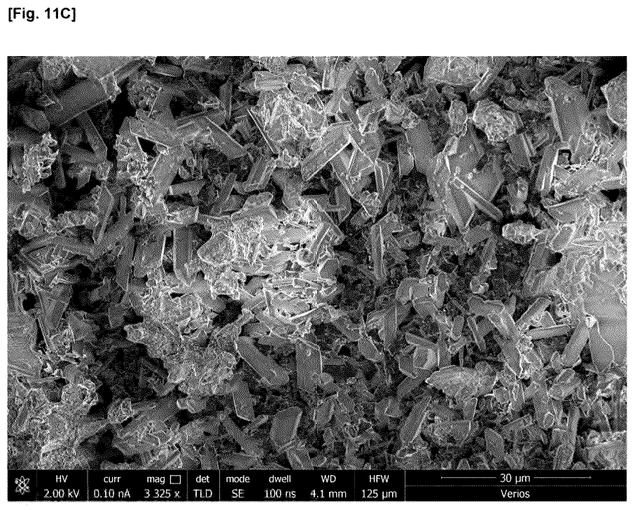

Referring to FIG. 10a, a lower chamber is constructed from SS316L grade stainless steel metal sheet, which is welded as shown in FIG. 10a. A recess is provided to position the membrane frame/slab with a thickness of 5-10 mm and an area of 0.441 m², the supporting bars and a flat rubber gasket at the upper portion of the lower chamber. The liquid withholds capacity is 0.00135 m³, i.e., 1.35 to 1.5 L of liquid. The chamber is designed for continuous operation with a liquid flow rate of 10-26 LPH and an operating temperature up to 120° C. Two supporting bars may be used to provide additional mechanical support to the membrane slab. A Straight Brass Hose Connector, ¼″ G male, ID ⅜″ may be fitted on opposite ends of the lower chamber for a liquid stream to be supplied to the lower chamber.

Referring to FIG. 10b, an upper chamber of VPM-02 may be constructed from SS316L grade stainless steel metal sheet, which is welded as indicated. The design comprises extended arms for the gasket to provide leak-proof contact with a flat rubber gasket. The gas withholds capacity of the upper chamber is 0.00225 m³, i.e., 2.25 L. The upper chamber may be designed for continuous operation of a gas flow rate of 10-20 LPM and an operating temperature up to 120° C. ¼″ FNPT is fitted on both sides of the upper chamber for gas tube connection.

Supporting bars/meshes may be constructed from SS316 seamless 148×5×3 mm metal bar, manufactured via CNC machining. This support may be used to provide additional mechanical sustenance to the membrane metal frame or the membrane slab.

The membrane frame may be constructed from SS316 seamless 298×148×5 mm metal bars, which are curved into a hollow frame using CNC machining. This frame is used to provide additional mechanical support to the flat membrane slab, which will be directly fabricated into it. It also provides leak-proof during module operation under elevated operating conditions, such as increasing temperature or pressure.

A composite membrane described herein may be fixed into the metal frame similar as performed for module VPM-01. The metal frame is fixed into the lower chamber. The rubber flat gasket is placed into the slot on the lower chamber to provide a leak-proof seal during operation. The device may be closed upon placing the upper chamber on top of the lower chamber and bolted with nuts and bolts along with a metal washer with sufficient tolerance.

### INDUSTRIAL APPLICABILITY

The disclosed composite membrane, separation device and separation apparatus may be used for non-contact separation of gaseous components from a liquid-gas mixture. For instance, the separation device and separation apparatus may be utilized to separate volatile materials such as ethanol from a liquid-gas mixture. Such separations may be particularly useful for the separation of ethanol from fermentation broth in the beverage industry. The separation device may also be coupled with chemical reactors in industrial production to remove gaseous components, which may drive the equilibrium of a chemical reaction.

It should be understood that although the present invention has been specifically disclosed by preferred embodiments and optional features, modification and variation of the inventions embodied therein herein disclosed may be resorted to by those skilled in the art and that such modifications and variations are considered to be within the scope of this invention.

### EXAMPLES

Non-limiting examples of the invention will be further described in greater detail by reference to specific examples, which should not be construed as in any way limiting the scope of the invention.

The modules are used for processing various liquid mixtures and separating products of commercial value from the same. Different graphene-based membranes have been implemented and tested according to different products to be separated. These processes exhibit long-term physical and chemical stability and separation efficiency. Separation factors vary for each specific process and are associated with the process volumes. A meaningful efficiency is obtained in the examples shown hereinafter.

The separation factor (a) in the gas-liquid separation process is calculated by the weight ratio of the product to be separated in the permeate collected in the upper chamber divided by the weight ratio of the product in the retentate remained in the lower chamber after the process.

The productivity of the separation process is expressed in a total mass flux, Jₜₒₜₐₗ, wherein Jₜₒₜₐₗ is calculated as,

Jₜₒₜₐₗ=m/At

wherein m is the mass of permeate collected over time t for a membrane of area A.

The pervaporation separation index (PSI) is calculated by:

PSI=Jₜₒₜₐₗ(α−1)

The pore size of the composite membrane was measured using Scanning Electron Microscopy (SEM) performed at a voltage of 2.0 kV and a current of 100 pA, with magnification of between 200× to 50000×. The composite membrane porosity can be measured by gas or liquid absorption (pycnometry). Pycnometry measurements were performed using nitrogen gas.

Separation of the gaseous components with the composite membranes described herein was performed continuously for a period of at least 2 months. Separation efficiency was maintained throughout this period.

### Example 1—Butanol

The separation of butanol from water with initial butanol concentration of 12 g/L was performed using the separation device VPM-02.

The composite membrane in this embodiment comprises 99.75 wt. % CaSO₄·2H₂O and a laminate of 0.25 wt. % graphene nanoplatelets, with a total thickness of 5 mm, porosity of about 27%, and pore size between 0.5 and 3 μm. The liquid flow rate in the lower chamber was 3.0 Uh, and the gas flow rate in the upper chamber was 2 L/min. The separation processes were performed at a temperature of 60° C. and atmospheric pressure. Separation factor of 25.7±1 and PSI of ˜1.0 kg/m2·h produced a permeate with around 40% of initial feed volume and concentrations of butanol up to 130 g/L. The separation device was set to process up to 5 L of feeding mixture per week as part of the up-scaling to pre-industrial quantities.

Accordingly, butanol from the fermentation broth was also successfully separated. In this case, Riboflavin or Vitamin B2 were maintained in the retentate.

### Example 2—Alcoholic Beverages

The separation of ethanol from alcoholic beverages with alcohol concentrations between 4.00% to 6.00% v/v was performed using the separation device VPM-01. The alcoholic beverages tested were beers, liquors, and synthetic mixtures prepared in laboratory.

The composite membrane used in this embodiment comprises 6 wt. % graphene oxide homogenously dispersed in 94 wt. % CaSO₄·2H₂O with total thickness of 3 mm, porosity of about 27%, and pore size between 1 and 10 μm. The liquid flow rate in the lower chamber was 0.4 L/h and the gas flow in the upper chamber was 0.8 m³/s. The separation process was performed at room temperature and atmospheric pressure. A separation factor up to 14.5±1 and PSI of up to 0.5 kg/m² h were achieved. The process produced a retentate with about 91% of the feed volume and concentration of alcohol was ≤0.5%.

### Example 3—Ethanol

The separation of ethanol from water using ethanol concentrations s 10% w/w was performed using the separation device VPM-01.

The composite membrane used in this embodiment comprises of 6 wt. % graphene oxide homogenously dispersed in 93.85 wt. % CaSO₄·2H₂O and a laminate of 0.15 wt. % graphene oxide with total thickness of 3 mm, porosity of about 27%, and pore size between 1 and 3 μm. The liquid flow rate in the lower chamber was 0.4 Uh, and the gas flow in the upper chamber was 2 L/min. The separation process was performed at temperatures between 30° C. to 60° C. and atmospheric pressure. A separation factor up to 6.0±1 and PSI of about 1.3 kg/m² h were achieved.

The process produced a permeate with concentration up to about 62% w/w ethanol and a retentate with about 93% of the feed volume and ≤1% w/w ethanol concentration.

### Example 4—Water

The separation of water from ethanol using ethanol concentrations a 95% w/w was performed using the separation device VPM-01.

The composite membrane used in this embodiment comprises 10 wt. % graphene nanoplatelets homogeneously dispersed in 89.75 wt. % CaSO₄·2H₂O and a laminate of 0.25 wt. % graphene oxide with total thickness of ˜3 mm, porosity of about 27%, and pore size between 0.5 and 3.0 μm. The liquid flow rate in the lower chamber was 0.4 L/h, The separation process was performed at temperature of 50° C. and atmospheric pressure. A separation factor of 7.2±1 and PSI of ˜0.2 kg/m² h were achieved. The process produced a retentate with around 93% of initial feed volume with an ethanol concentration increase of at least 0.5% w/w. The final ethanol concentration in the retentate can reach up to 99.8% w/w.

1. A composite membrane comprising at least one two-dimensional material and an inorganic porous material.

2. The composite membrane of claim 1, wherein the inorganic porous material is a hydrophilic inorganic porous material.

3. The composite membrane of claim 1, wherein the inorganic porous material is selected from the group consisting of ceramics, clays, gypsum, hydroxyapatite, silicates, industrial ceramics, powder metallurgy materials, zeolites, and combinations thereof.

4. The composite membrane of claim 3, wherein the inorganic porous material is gypsum.

5. The composite membrane of claim 1, wherein the 2D material is homogeneously dispersed in the inorganic porous material and/or is laminated on at least one surface of the inorganic porous material.

6. The composite membrane of claim 1, wherein the inorganic porous material is present in an amount from 70 wt. % to 99.9 wt. % based on the total weight of the composite membrane.

7. The composite membrane of claim 1, wherein the two-dimensional material is selected from the group consisting of graphene oxide, graphene nanoplatelets, reduced graphene oxide, molybdenum disulfide, hexagonal boron nitride, phosphorene, transition metal dichalcogenides, xenes, and mixtures thereof.

8. The composite membrane of claim 7, wherein the two-dimensional material is selected from graphene oxide, graphene nanoplatelets, or a mixture thereof.

9. The composite membrane of claim 1, wherein the two-dimensional material is present in an amount of from 0.1 wt. % to 20 wt. % based on the total weight of the composite membrane.

10. The composite membrane of claim 9, wherein the two-dimensional material is present in an amount of from 0.25 wt. % to 10 wt. % based on the total weight of the composite membrane.

11. The composite membrane of claim 1, wherein the composite membrane comprises an average pore size between 0.1 μm to 50 μm.

12. The composite membrane of claim 11, wherein the composite membrane comprises an average pore size between 0.5 μm to 10 μm.

13. The composite membrane of claim 1, wherein the composite membrane is substantially free of organic matter.

14. A separation device comprising:
an upper enclosed chamber configured to receive a gaseous component;
a lower enclosed chamber in fluid communication with the upper chamber and configured to receive a fluid stream comprising at least one gaseous component,
said upper and lower chambers being partitioned by at least one composite membrane, wherein composite membrane is configured to allow passage of said gaseous component from the lower chamber to the upper chamber, and
wherein said composite membrane comprises at least one two-dimensional material and an inorganic porous material.

15. The separation device of claim 14, wherein the thickness of the composite membrane is 1 mm to 10 mm.

16. The separation device of claim 14, wherein the surface area of the composite membrane is 0.001 to 0.6 m².

17. The separation device of claim 14, wherein the volume of the upper and lower chamber may be, independently, 70 cm³ to 0.005 m³.

18. The separation device of claim 14, wherein the upper chamber further comprises an outlet for discharging the gaseous component; and the lower chamber further comprises an outlet for discharging the fluid stream comprising a reduced amount of the gaseous component.

19. The separation device of claim 18, wherein the discharged fluid stream is substantially free of the gaseous component.

20. A separation apparatus comprising a plurality of separation devices , said separation devices comprising:
an upper enclosed chamber configured to receive a gaseous component,
a lower enclosed chamber in fluid communication with the upper chamber and configured to receive a fluid stream comprising at least one gaseous component,
said upper and lower chambers being partitioned by at least one composite membrane, wherein composite membrane is configured to allow passage of said gaseous component from the lower chamber to the upper chamber,
wherein said composite membrane comprises at least one two-dimensional material and an inorganic porous material; and,
wherein said plurality of separation devices may be operated in series or operated to receive a fluid stream from a common feedstock.
